(19) United States
(12) Patent Application Publication
(10) Pub. No.: US 2010/0153212 A1
(43) Pub. Date: Jun. 17, 2010

(54) TRAVEL INDUSTRY MARKETING PLATFORM

(75) Inventor: Martin Stoll, Portland, OR (US)

Correspondence Address: Schwabe Williamson & Wyatt;PACWEST CENTER, SUITE 1900, 1211 SW FIFTH AVENUE, PORTLAND, OR, 97204, US

(73) Assignee: GoSeeTell Network Inc., Portland, OR (US)

(21) Appl. No.: 12/710,753

(22) Filed: Feb. 23, 2010

Related U.S. Application Data
(62) Division of application No. 11/625,157, filed on Jan. 19, 2007.
(60) Provisional application No. 60/763,833, filed on Jan. 30, 2006.

(30) Foreign Application Priority Data
Jan. 30, 2007 (US) PCT/US2007/061284

(51) Int. Cl. G06Q 30/00; G06Q 50/00

(52) U.S. Cl. 705/14.52; 705/14.66

(57) ABSTRACT

Embodiments of the present invention provide travelers with the ability to get travel advice and travel related information from other users by using the collective intelligence of a web-based social network as well as using the social network for creating marketing and advertising opportunities for travel suppliers.

### CROSS REFERENCE TO RELATED APPLICATIONS

The present application claims priority to U.S. Provisional Patent Application No. 60/763,833, filed Jan. 30, 2006, entitled “COLLECTIVE INTELLIGENCE RECOMMENDER SYSTEM FOR TRAVEL INFORMATION AND TRAVEL INDUSTRY MARKETING PLATFORM,” the entire contents of which are hereby incorporated by reference in their entirety.

### TECHNICAL FIELD

Embodiments of the present invention provide travelers with the ability to obtain travel advice and travel related information from other users by using the collective intelligence of a web-based social network. The social network may also be used for creating marketing and advertising opportunities for travel suppliers by allowing suppliers to create highly targeted marketing messages. Embodiments of the present invention allow travelers to obtain recommendations for travel products that match their interests and/or lifestyle.

### BACKGROUND

Buying travel products is a complicated decision that comes with higher purchasing risks for buyers than the purchase of other products. Unlike other products (e.g. a CD), travel purchases (e.g. a vacation in Hawaii, a flight to Europe, etc.) may not be tested or experienced before use and the products may not be returned or exchanged for other products if the products did not deliver the expected experience or performance. Buyers therefore rely heavily on recommendations of “experts” like travel agents, guidebooks or the Internet. However, these “experts” almost never know all the travel preferences of the user and have no reasonable means to compare the preferences and past travel experiences of the buyer with those of other users. Thus, there remains a need for a system that may provide more accurate and higher quality travel recommendations.

At the same time, suppliers of travel products suffer from an increasing commoditization of travel products. The commoditization of travel products creates problems for suppliers as consumers focus mainly on price differences and not on product differences when making purchasing decisions. Thus, there is a need for a marketing system that allows travel suppliers to deliver customized products that match the interests of the users and thereby avoid commoditization.

### BRIEF DESCRIPTION OF THE DRAWINGS

Embodiments of the present invention may be readily understood by the following detailed description in conjunction with the accompanying drawings. Embodiments of the invention are illustrated by way of example and not by way of limitation in the figures of the accompanying drawings.

FIG. 1 is an overview diagram that illustrates an Internet-related architecture in accordance with various embodiments of the present invention;

FIG. 2 is an overview of various data flows in accordance with an embodiment of the present invention;

FIG. 3 illustrates how data on a database may be split between shared and exclusive data in accordance with an embodiment of the present invention;

FIG. 4 illustrates a flow chart of a sign-up process for a user in accordance with an embodiment of the present invention;

FIG. 5 is an overview of user options and functions in accordance with an embodiment of the present invention;

FIG. 6 illustrates, as an example, different functionalities available to users to update, maintain and/or work with a user profile in accordance with an embodiment of the present invention;

FIG. 7 illustrates an example of how users may set different parameters for sharing data in accordance with an embodiment of the present invention;

FIG. 8 illustrates different types of data that users may enter into a database as well as other data that may populate the database in accordance with an embodiment of the present invention;

FIG. 9 is an overview of categories in which users may post, review and/or read data in accordance with an embodiment of the present invention;

FIG. 10 illustrates a geographic structure of data and a database in accordance with an embodiment of the present invention;

FIG. 11 is an exemplary screen shot of a content filtering system in accordance with an embodiment of the present invention;

FIG. 12 is an exemplary screen shot showing how users may rate information provided by other users in accordance with an embodiment of the present invention;

FIG. 13 is a diagram that illustrates how data may be used to build different user clusters in accordance with an embodiment of the present invention;

FIG. 14 is an exemplary screen shot showing examples of user profiles grouped into user clusters in accordance with an embodiment of the present invention;

FIG. 15 shows a schematic overview of a recommender system that may allows users to obtain travel recommendations based on the collective intelligence gathered in a database in accordance with an embodiment of the present invention;

FIG. 16 is a diagram illustrating how user and supplier data may be stored in the same central database in accordance with an embodiment of the present invention;

FIG. 17 is a flow chart illustrating a sign-up process for travel suppliers in accordance with an embodiment of the present invention;

FIG. 18 is a flow chart illustrating a data entry process for suppliers in accordance with an embodiment of the present invention;

FIG. 19 illustrates different options suppliers may have for different marketing activities in accordance with an embodiment of the present invention;

FIG. 20 illustrates how suppliers may use a database in accordance with an embodiment of the present invention to model marketing activities according to preferences and according to the users they want to target;

FIG. 21 is a diagram that illustrates how an embodiment of the present invention may connect user preferences and supplier preferences on a marketing platform;

FIG. 22 is a schematic illustration that shows how different advertising is shown to different users depending on selected criteria for targeting the different users in accordance with an embodiment of the present invention;

FIG. 23 is a schematic illustration that shows how users may use a “booking basket” tool to simultaneously retrieve proposals and prices from multiple suppliers in accordance with an embodiment of the present invention; and

FIG. 24 is a schematic illustration that shows how users may transfer content from a database to other media using a “transfer basket” tool in accordance with an embodiment of the present invention.

### DETAILED DESCRIPTION OF EMBODIMENTS OF THE INVENTION

In the following detailed description, reference is made to the accompanying drawings which form a part hereof, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “NB” means A or B. For the purposes of the description, a phrase in the form “A and/or B” means “(A), (B), or (A and B)”. For the purposes of the description, a phrase in the form “at least one of A, B, and C” means “(A), (B), (C), (A and B), (A and C), (B and C), or (A, B and C)”. For the purposes of the description, a phrase in the form “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

In various embodiments of the present invention, methods, apparatuses, and systems for providing travelers with the ability to obtain travel advice and travel related information from other users by using the collective intelligence of a web-based social network are provided. In embodiments, a social network may also be used for creating marketing and advertising opportunities for travel suppliers by allowing suppliers to create highly targeted marketing messages.

Embodiments of the present invention allow travelers to obtain recommendations for travel products that match their interests and/or lifestyle. Embodiments of the present invention provide a marketing system that allows travel suppliers to deliver highly targeted messages to consumers with the messages taking the different travel preferences and/or lifestyles of the consumers into account. Such targeted messages allow suppliers to offer customized products that match the interests of the user.

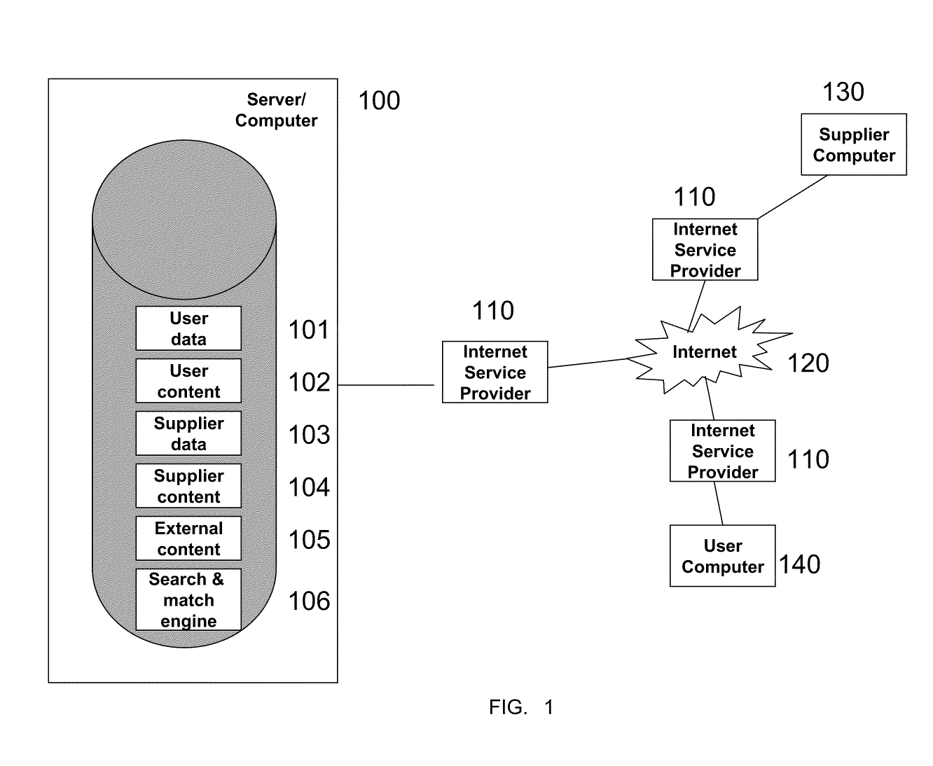

FIG. 1 is a diagram showing the architecture of a server containing data as well as its connection to the computers of users and suppliers via the Internet in accordance with an embodiment of the present invention. It should be understood that other forms of storing, processing and delivering the data may equally well be used within the scope of embodiments of the present invention. A central server 100 may hold relevant information such as data about users 101 (preferences, demographics etc.), content provided by users 102 (reviews of accommodations, attractions, restaurants, etc. as well as the rating of those), supplier data 103 (contact information, category information etc.), content provided by suppliers 104 (such as descriptions of products, photos, links etc.) and external content 105 that may be provided by other sources. The data may be used by a search and match engine 106 to deliver relevant and/or customized content and information to users and/or suppliers. The data may be delivered to supplier computers 130 and user computers 140 via Internet service providers 110 and the Internet 120.

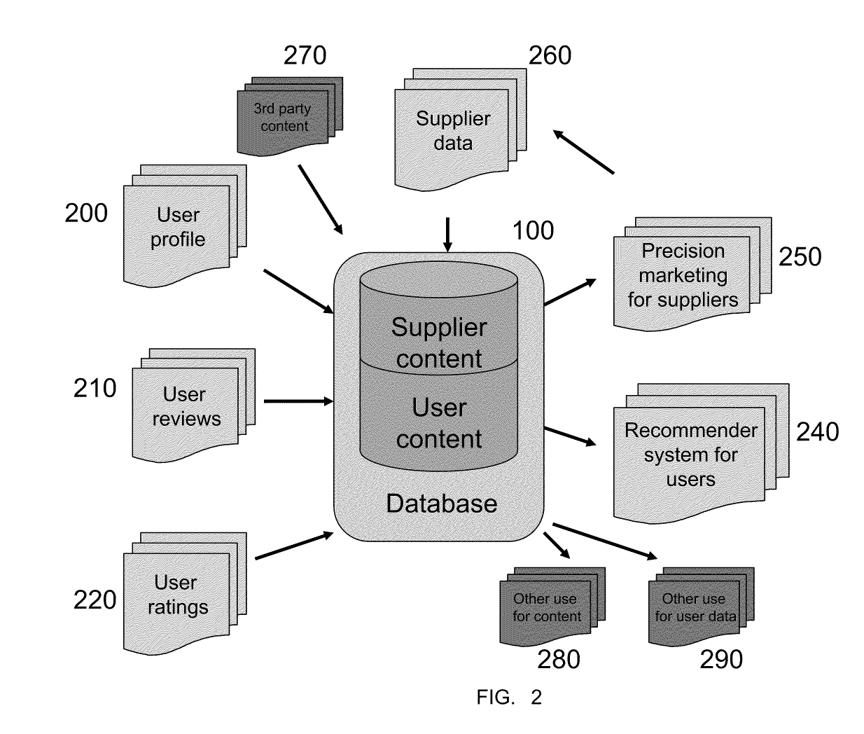

FIG. 2 provides an overview of data flows in accordance with an embodiment of the present invention. Users may enter a user profile 200 that includes demographic information as well as information about their travel preferences regarding type of preferred vacations, accommodation, mode of transportation, restaurant preferences, etc. In an embodiment, a method may be provided to identify user travel preferences by combining information from a user profile with reviews and ratings by the user.

In an embodiment, users may then add information about travel products they have experienced in the past (“prior experiences”), for example, in the form of user ratings and/or user reviews 210. As part of this information, users may also upload photos, audio and/or video in the database so the information may be shared with other users. As a further source of information, users may rate information they find in database 220. For example, users may rate a restaurant or a hotel and by doing so may share with other users their opinion(s). Users may also rate reviews written by other users, therefore indicating whether they find the information provided by other users helpful or not.

In embodiments, most any type of suitable information that is part of the database may be rated by a user and/or a supplier. The ratings may be used by the users to determine the relative rankings of various elements as well as to determine the highest rated items in particular categories (for example, the highest rated restaurant, or the most useful advertisement, etc.).

In an embodiment of the present invention, a method is provided to identify users that are considered experts by other users or based on criteria within the system. In an embodiment, a user may be determined to be an expert when such a user has met certain pre-established guidelines or thresholds. In an embodiment, expert users may be identified by, for example, accumulating the helpfulness ratings (which, in an embodiment, may be assigned a value by the system) that other users have assigned to reviews of the respective user as well as other factors such as the time the user has been using the system, the number of reviews that user has written, etc. In an embodiment, different levels of experts may be identified through different labels, names and/or symbols.

In an embodiment of the present invention as shown in FIG. 2, identified user preferences may be used to provide customized recommendations to users by comparing and clustering users, user preferences and/or user ratings in a recommender system 240. In an embodiment, a user query for travel recommendations may return specific recommendations and/or may return names/links to other users that the system determines may have useful information or may be able to provide such useful information. In an embodiment, the system may determine that the user has a closely matching rating of a prior experience with that another user and may use that to determine that the second user may be able to provide a valuable recommendation to the first user for a new experience.

In an embodiment of the present invention, the content of the database and/or user data, especially user preferences and demographics, may be used for precision marketing 250 by tourism and travel suppliers (hotels, airlines, restaurants, destination marketing organizations, etc.). In an embodiment of the present invention, to participate in the marketing activities, a supplier first registers with the system and lists its product as supplier data 260 in the database. The supplier data itself may be available for users to read and review which, in an embodiment, creates more information about user preferences.

In an embodiment, a supplier may then create marketing/advertising messages and select to which subset of the users the message will be shown. As an example, a hotel may create a marketing message and select that this message is to be shown only to members who—according to their user profile—are female, over 45 years of age and are interested in resort hotels. The highly targeted marketing messages are more relevant for the individual member to whom the messages are shown thus making it more likely that the member will react to the message. The higher response rates may lead to better returns on marketing investments for the participating suppliers. In an embodiment of the present invention, the precision marketing tool may also be made available to non-registered travel suppliers as well as suppliers of other products that are not travel-related.

In addition to data from users and suppliers, the database may also include data from other sources 270, including but not limited to other web-pages, other databases, marketing partners, etc.

In an embodiment of the present invention, information collected in the database may also be used for additional purposes. Such purposes include, but are not limited to, using the content of the database to generate guidebooks or other forms of travel information 280 as well as using the information about users, their preferences and/or user clusters for different web-applications, web-pages or the production of other content 290 such as TV shows, etc.

In an embodiment of the present invention, recommendation rules may be established in a recommendation system, such rules derived from, for example, automatic generation machine learning, automatic generation using a generic algorithm, automatic generation using a neutral network, automatic generation using a rule inference system, data mining, generation using a preset list of recommendations, and/or a user specification. In an embodiment, a system may be configured to receive recommendation rules such as unidirectional rules, bidirectional rules, generalized rules including multi-way rules, rules among items, rules among sets, rules among collections, rules with weight factors, rules with priorities, and/or un-weighted and un-prioritized rules.

In an embodiment, recommendations may be filtered in advance of display. In an embodiment, filtered recommendations may be derived only from those other users that have added the data (review, rating) within a specified time, from those other users that share specific similarities with the user, those other users that have been preselected by the user as relevant (by reviews, ratings, matching characteristics), those other users that are selected as friends or friends of friends, etc., those other users that are determined to provide valuable reviews/ratings or are specifically declared to be experts within the system or by the user, or those other users that have entered at least a minimum amount of data into the system. In another embodiment, filtered recommendations may be provided for places within a certain distance from another location, places that have received a minimum rating from other users, places that have been rated within a specific time period, or places that have been rated a specific number of times.

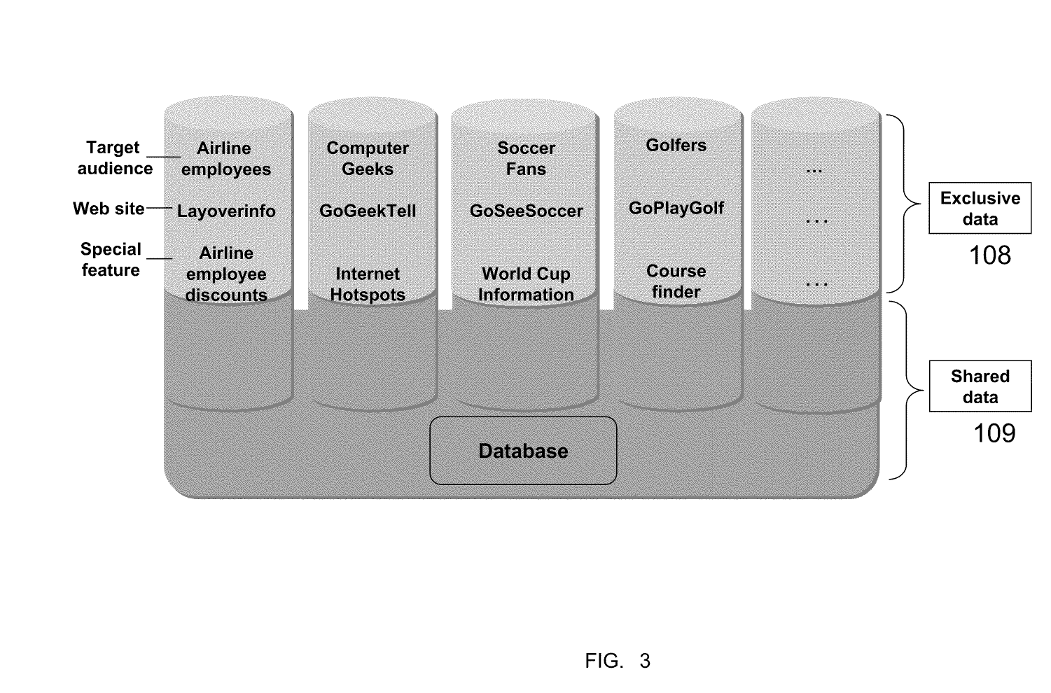

FIG. 3 illustrates an overview of a database structure in relation to different user groups in accordance with an embodiment of the present invention. The content of the database consists of shared data 109, which all users may access as well as exclusive data 108, which only users that belong to a certain user group may access. This embodiment of the present invention may enable users to decide what information they want to share with which other users by designating the degree of exclusivity of the data and thus may lead to more relevant information being provided to users. In addition, in an embodiment, users may assign filters or blocks to prevent seeing information pertaining to certain subjects or coming from certain other users or suppliers.

An embodiment such as shown in FIG. 3 provides user groups with a target audience or unifying characteristic for the group, such as soccer fans, and, in an embodiment, a sub-site for the group. In addition, in an embodiment, special features or offers may be provided only for a particular user group, such as providing a golf course finder for the golfers' user group.

In an embodiment of the present invention, user groups may build customized sub-sites according to the needs of their specific user group, like employees of a company or alumni of a university. For example, employees of a certain company may use the tool, the algorithms and the existing database to create a special sub-site only for the employees of the company. Some of the data of the employees and some of the content generated by the employees may be shared with all other users and all other sub-sites, and some content may be exclusively for members of the company's sub-site. In an embodiment, all different sub-sites may be connected and interlinked to a network of sub-sites allowing users of one sub-site to share and access information created by users of another sub-site.

In an embodiment, a sub-site may be established providing the members a degree of control over the content and/or functionality of the system. For example, a particular authorized individual within a company, such as a sub-site administrator or travel manager, may identify within the sub-site such company specific information as preferred hotels at which the company has negotiated special rates, the per diem allocated for particular levels of the employees or for particular locations. In an embodiment, the reimbursement policies of the company may be integrated into the sub-site to provide an indication of preferred or approved options. In an embodiment, a direct booking or “Book it Now” option may be provided within a sub-site. Such a direct booking option may include integrated payment options established by the company such as “do not exceed” caps, authorized providers (airlines, hotels, rental cars) as well as payment options that allow payment to be handled directly by the company (as opposed to paid by the employee and then submitted for reimbursement).

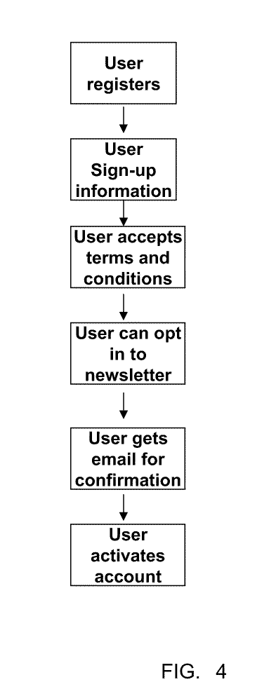

FIG. 4 is an illustration of a sign-up process for users. In an embodiment of the present invention, to sign-up, a user generally provides some basic registration and sign-up/demographic information and accepts the terms and conditions of the system. In an embodiment, a user may opt in or out of certain features such as email alerts and/or newsletters, etc. In an embodiment, a confirmation is typically generated and may be confirmed by email or other suitable source. In embodiments, the user may then request a personal account to be created, which may be activated, for example, by sending the user an email and, in an embodiment, requesting a particular action by the user, such as following a hyperlink.

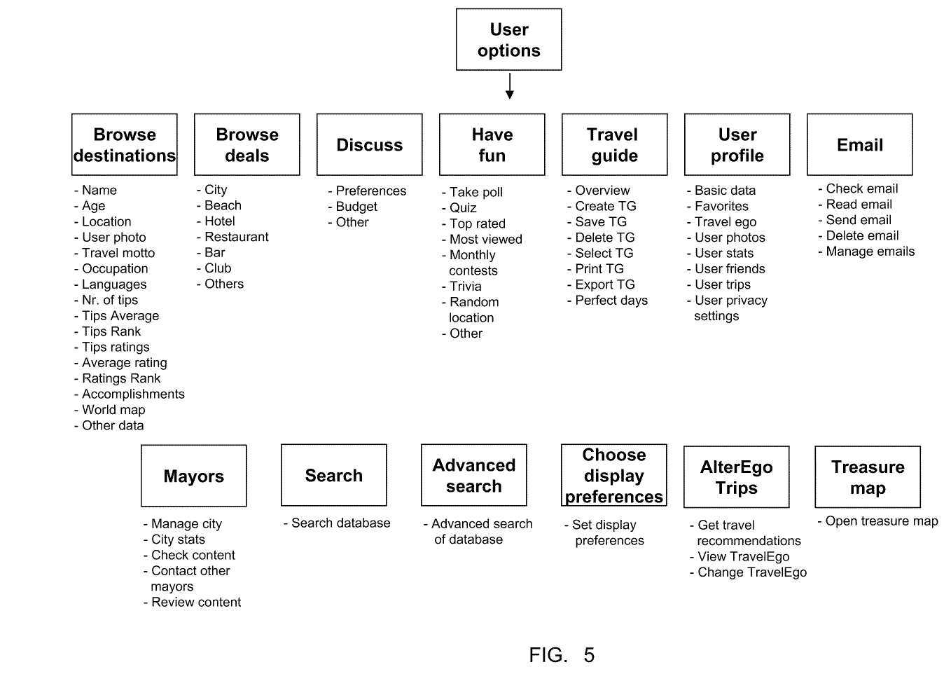

FIG. 5 illustrates how, once a user has signed up, an embodiment of the present invention may allow the user to perform a wide variety of different tasks and choose from selectable items, such as searching or browsing the database by various criteria to find information relevant to the user, searching the database to find special offers that are relevant to the user, performing functions that may offer entertainment for the user such as quizzes, polls, statistics, rankings, etc.

In an embodiment of the present invention, users benefit from the option to select relevant information from the database, sort it and create a customized travel guide that may be stored, shared and/or printed. In an embodiment, the system may provide an integrated function by which a user may create a travel guide including maps, reviews, details of particular sites (such as locations of interest, for example, museums, parks, etc.) and/or providers (such as hotels, etc.). This information may be sorted, stored, printed, shared, and/or exported to a device such as a PDA for later use.

In embodiments, users may also have the option to view, add to, delete, change and manage the information in their user profile and their user preferences.

In an embodiment of the present invention, users may also be able to connect with other users via a closed email and/or chat system or instant messaging.

Furthermore, users that meet certain criteria (demonstrated knowledge, acceptance by other users by vote, review, comment, survey, etc.) may obtain a super-user or special status (such as “Mayor”) that may allow them to manage certain content elements of the database. In an embodiment of the present invention, users may apply and be approved for super-user status by an administrator, by users, or a subset thereof, such as other super-users. A special status may be granted for a limited or extended amount of time. In an embodiment, the special status may be displayed in the profile of the user. In an embodiment, the status furthermore may allow the user to connect with other super-users. The status may also give users the possibility to participate in further development, such as development of the database, the applications of the database and/or the website in general. In an embodiment of the present invention, there may be multiple attainable status levels based on any desired criteria and/or administrator or user input.

As further options, a user may search the database for members or content with a simple or an advanced search function. The user may search the database for other members that share the user's interests or travel preferences or search for members that have been to, rated, or reviewed certain places.

In an embodiment, a user may furthermore choose the information from the database the user wants to be displayed to him by choosing between various options that range from displaying all data in the database to only displaying the information relevant to the clusters the user is in. As shown in such an embodiment, the user may thus make a selection in advance of viewing data to have the data sorted or filtered in accordance with certain criteria, such as requiring the data to be pertinent to a particular user group or only displaying data that has been recently added to the system, etc.

In an embodiment, a user may, for example, query the database to find information that other users with a profile similar to the first user have rated highly, e.g. a user who is traveling with small children may filter the database to show restaurants that other users who have traveled with children have rated as well suited for families with children. Such an embodiment may use various profile data, user preferences, etc. to determine a suitable query result.

As an alternative embodiment of the present invention, a user may also use a recommender function (“AlterEgoTrips”) that may use data collected in the database to display information to the user by querying with data from a temporary profile, identified preferences, etc. In such an embodiment, a user has the option of adopting an alternative profile or persona with one or more alternative characteristics to obtain different recommendations than the system would otherwise return for a query recommendation based on the user's established profile. In such an embodiment, a user may thus adapt a different persona, for example one that is more adventurous, to obtain a recommendation of something different for the user but based on a defined temporary profile established by the user.

In an embodiment, a user may also use a special function (such as a “treasure map”) to view selected, customized information that is generated for that user and/or available only to that user. This information may include e.g. special offers, recommendations, etc. In an embodiment of the present invention, such a specialized feature may be utilized to provide highly targeted marketing and/or recommendations specific to that user. In an embodiment, the targeted messages, offers, recommendations, etc. are generated and matched to the user based on the data in the user's profile. Such a targeted marketing feature may be provided through a treasure map function and/or may be provided through other direct display means, for example during a search conducted by a user, as discussed above.

Thus, in an embodiment of the present invention, a method is provided comprising registering by a server a new user; receiving in a database of the server a user profile provided in connection with the user registration; receiving in a database of the server information about demographic information and/or preferences of the user, receiving in a database information about reviews and ratings from the user and combining this information with information received in a database of the server by suppliers about travel related products. In an embodiment of the present invention, a method is provided to use information in the database to cluster users according to data they provide, as well as enabling users to use a recommender application to filter data from the database according to certain, determined criteria.

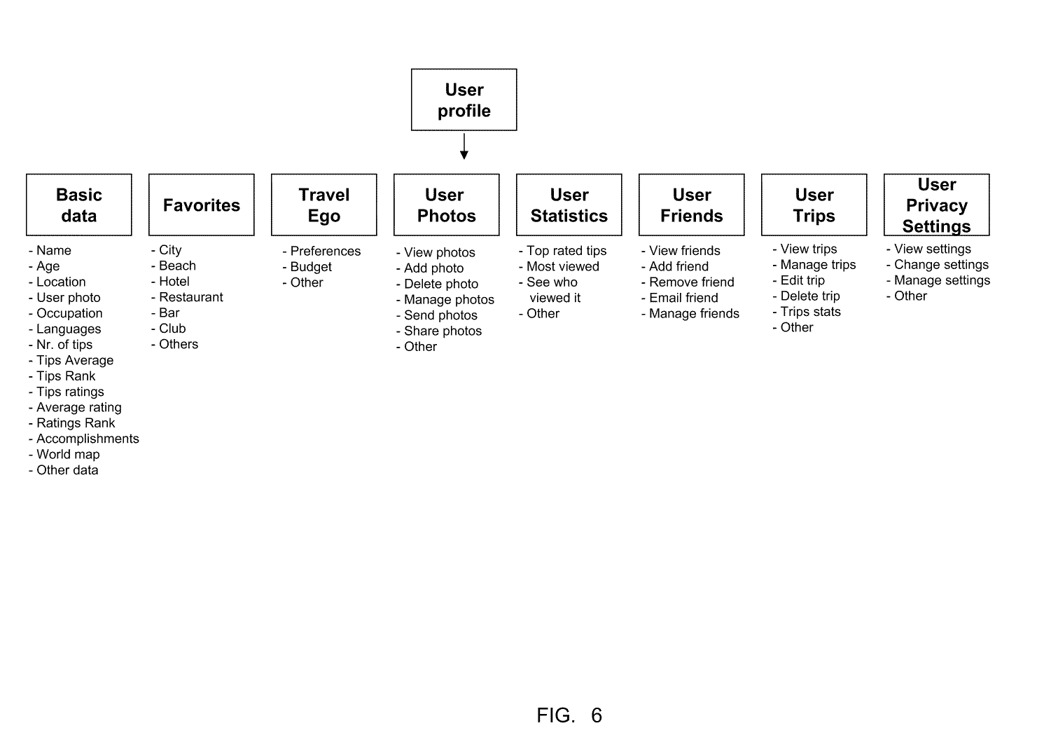

In an embodiment of the present invention, a user has multiple options for using his user profile as shown in FIG. 6. The user may view, update and/or delete general user data such as age, location, a user photo, etc. The user may also see how many reviews (“tips”) the user has posted, how other users have rated the user's reviews, how many other reviews the user has rated, etc. Out of all reviews, the user may furthermore choose the user's favorites for different categories of the database, which the user may opt to share with other users.

In an embodiment of the present invention, a user may provide additional information about his travel preferences such as budget for travel, hotel preferences, the type of vacation the user likes, etc. that may be stored in the user's profile.

In an embodiment, users may also upload, review, sort, delete, describe and/or attach descriptive tags to photos or videos, which may be shared with other users. In an embodiment, users may invite other users to assign each other a special status, such as “friend” status, that may give the users special privileges for accessing and reviewing data of the other user. In an embodiment, a user may also review extensive statistics of all the information they provide to the database and/or keep track of all their travels.

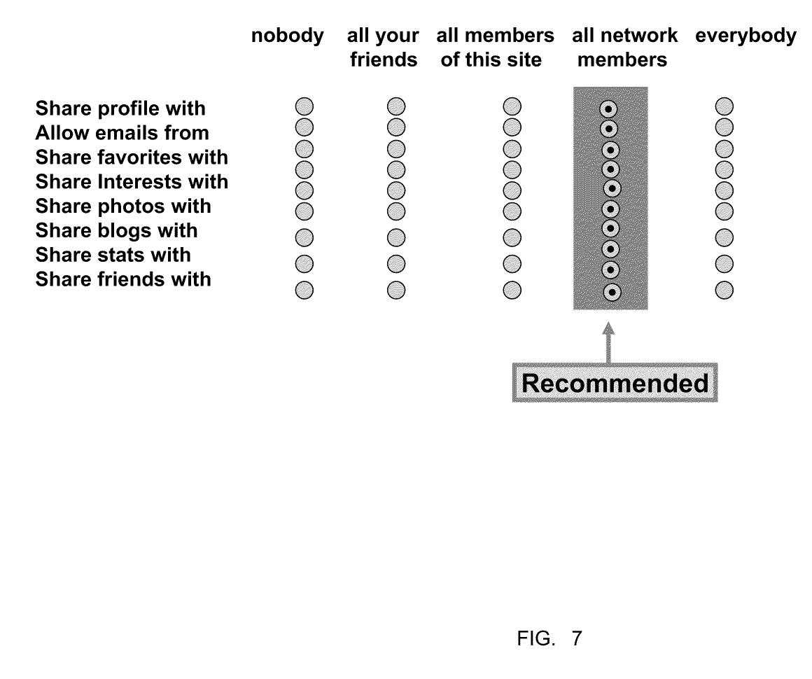

In an embodiment of the present invention, users may set privacy parameters that allow them to choose the information they want to share with whom. FIG. 7 provides an example of how users may manage their privacy settings in accordance with an embodiment of the present invention.

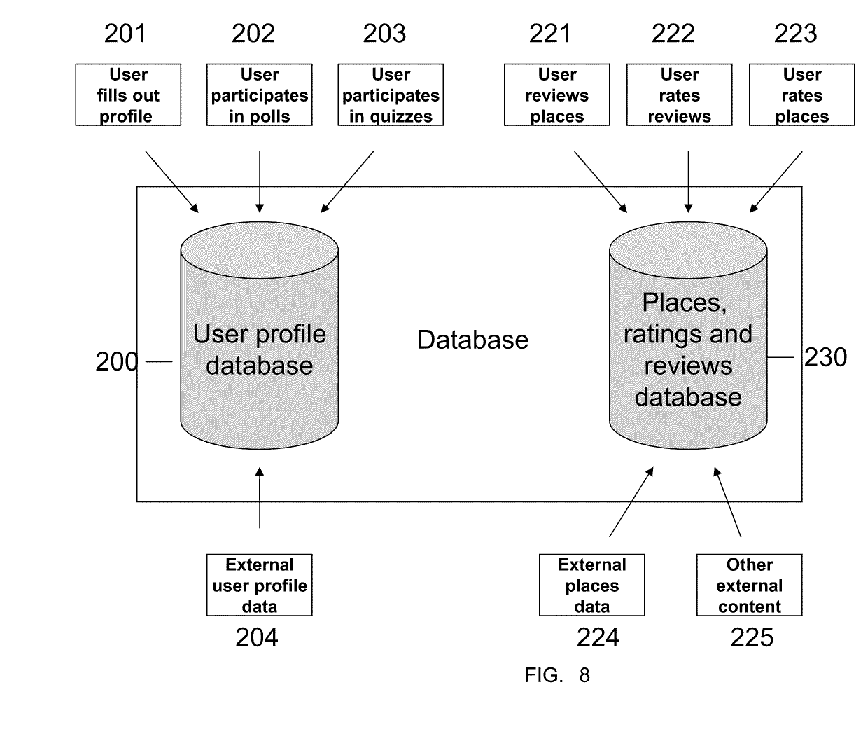

FIG. 8 illustrates how, once a user is registered, the user may provide additional information to the database in accordance with an embodiment of the present invention. In an embodiment, the user may add data to the user profile database by filling out a user profile form 201. The user may also participate in polls 202 or quizzes 203 from which the user's answers may be stored and used to complete the user profile. Additionally, external sources 204 may be used to get user profile information.

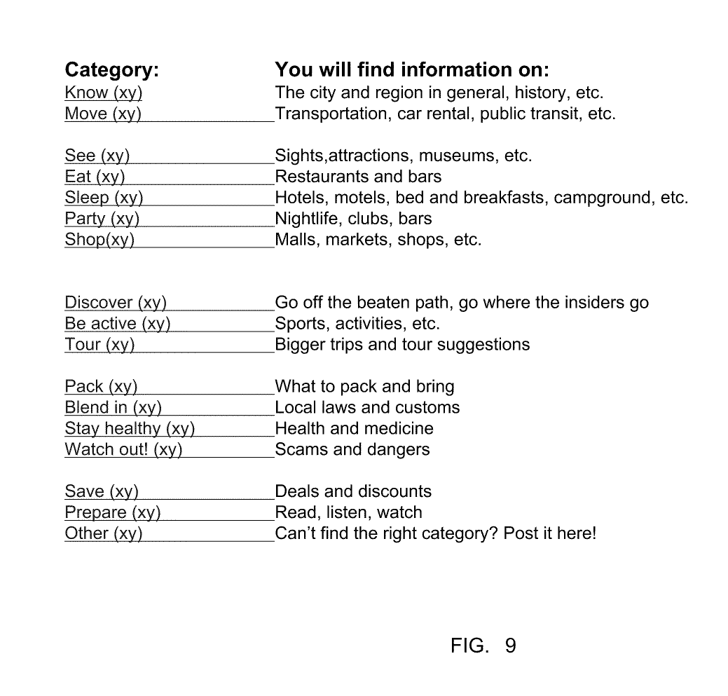

A registered user may also provide reviews about places 221 (hotels, attractions, restaurants, etc.), may rate places 223, and/or may rate the reviews provided by other users 222. All information may be stored in one or more databases (200 and 230) and may be used in embodiments of the present invention. In addition, external data 224 (e.g. geographic information) as well as external content 225 may be added to the database. An example of different categories in which the data of the database may be stored is shown in FIG. 9.

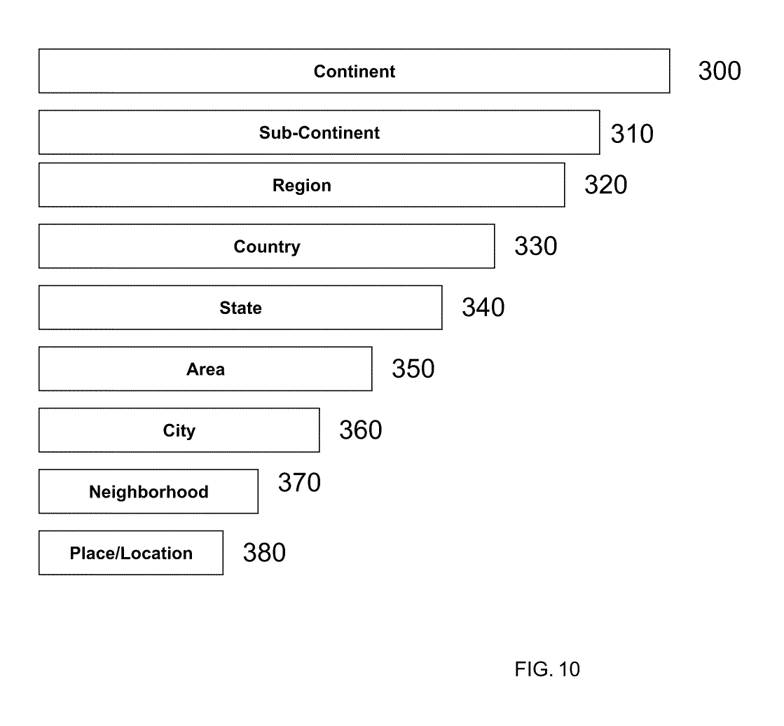

FIG. 10 is an overview of a geographic structure of data in accordance with an embodiment of the present invention. Continents 300 may be divided into sub-continents 310 that may consist of several different regions 320. The regions may include several different countries 330, which may include states 340. The states may be divided into different areas 350, which may in turn include different cities 360. The cities may be divided into different neighborhoods 370 which may include information about different places or locations 380.

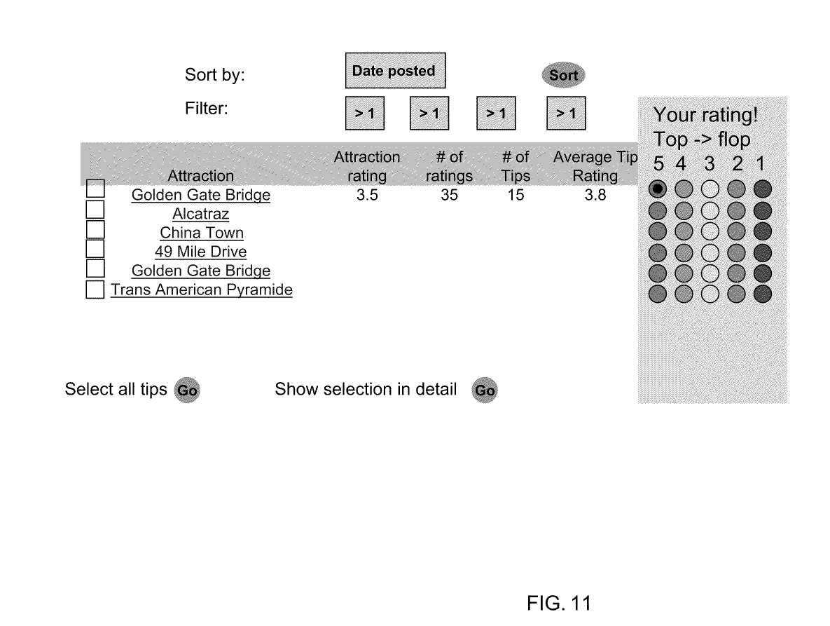

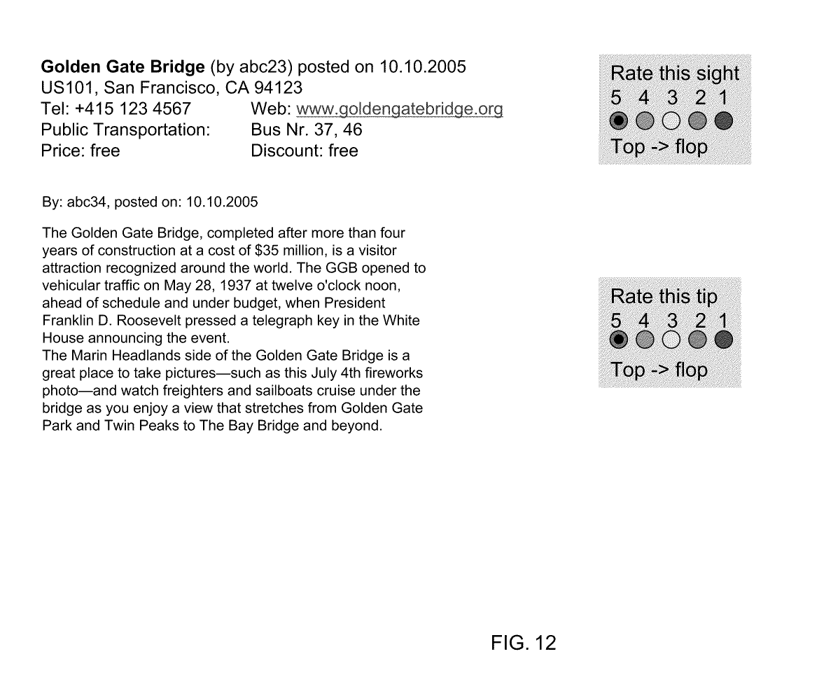

FIG. 11 illustrates how users may search, filter, select and/or rate information about different places they find in accordance with an embodiment of the present invention. FIG. 12 illustrates how users may also rate reviews provided by other users.

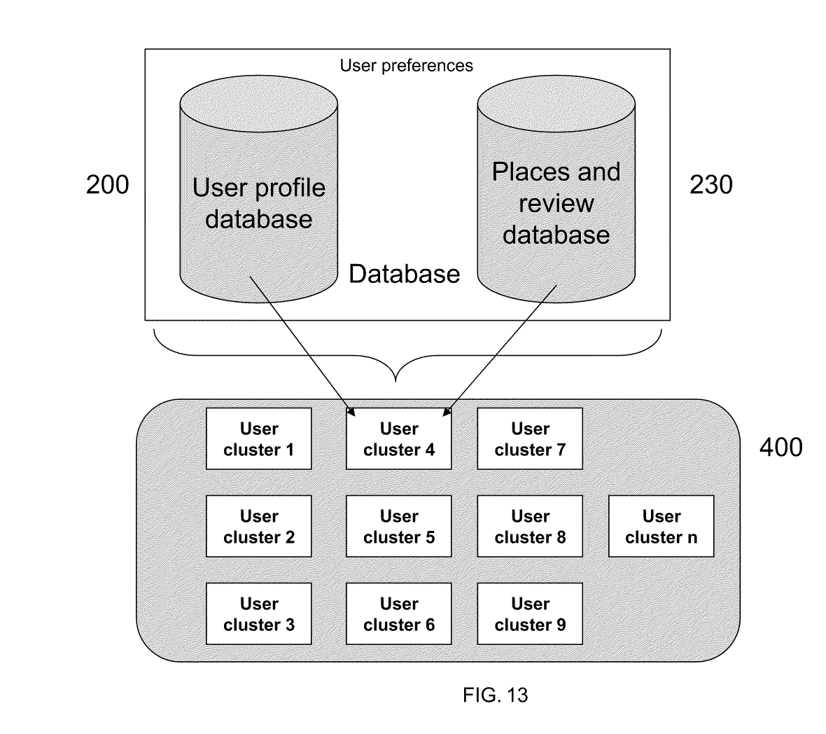

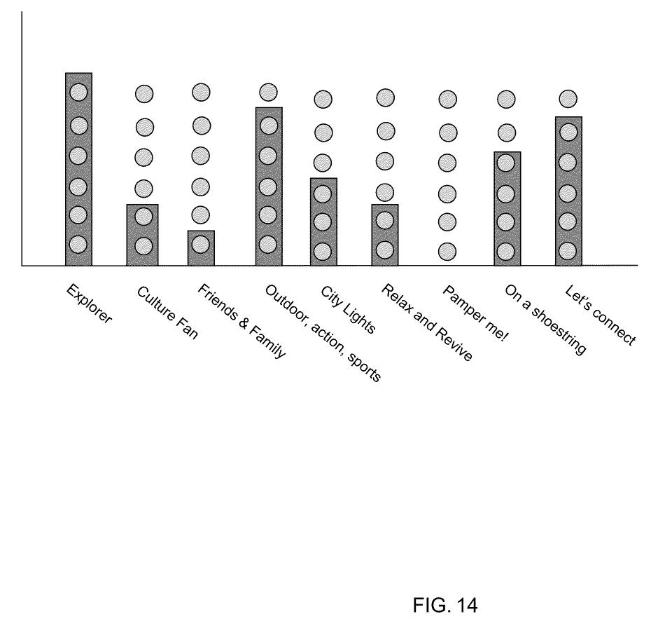

FIG. 13 shows how information in one or more databases (200 and 230) may be used to group users into different user clusters 400 based on their profiles, preferences, ratings and/or reviews in accordance with an embodiment of the present invention. Clusters may be created by grouping users that have similarities in one or more categories. Depending on the number of users and the degree of similarities of the users, different clusters and/or different numbers of clusters may be created. In an embodiment of the present invention, it may be possible for one user to be included in several different clusters. An example of possible different clusters and how a user may fit into those clusters is provided in FIG. 14.

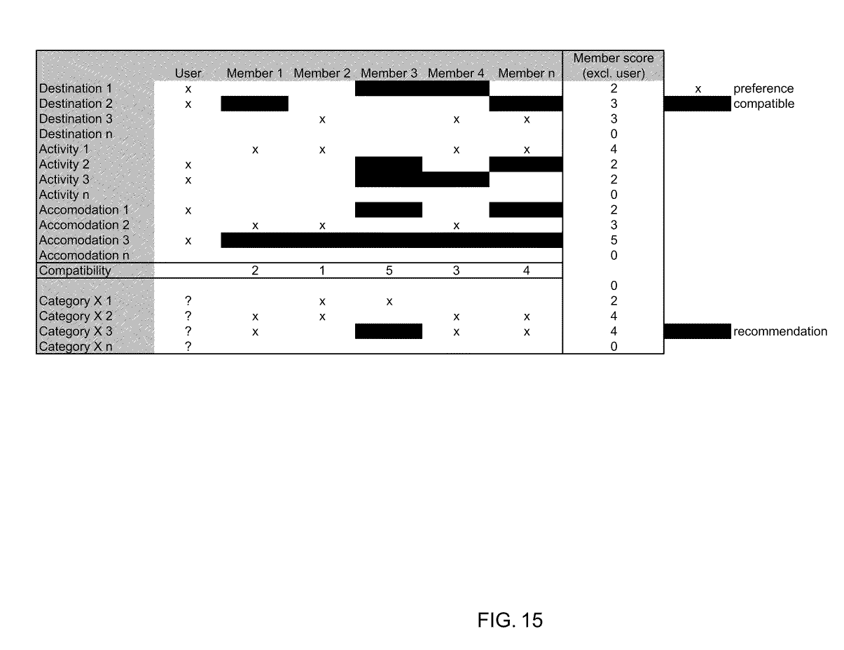

FIG. 15 outlines a recommender functionality in accordance with an embodiment of the present invention. Users may indicate their preferences for certain places/information in the database. With this data, an embodiment of the present invention is able to return recommendations of places/information to the user by using ratings and demographic information provided by other users.

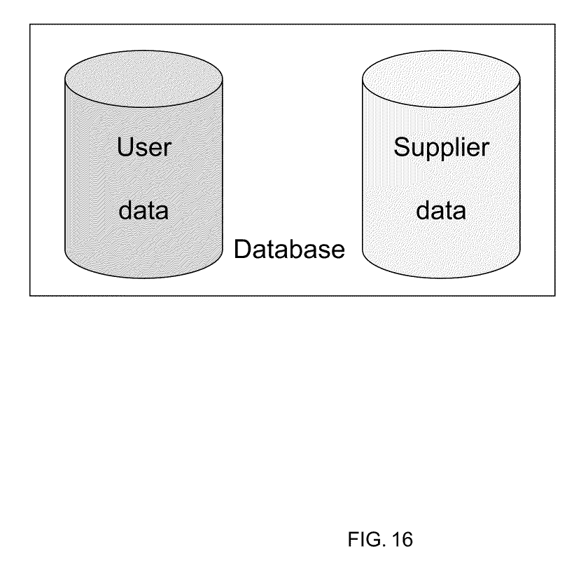

FIG. 16 illustrates how the database combines information from users and suppliers in accordance with an embodiment of the present invention. In an embodiment of the present invention, a method is provided that allows suppliers of travel related products to use the user information available in the user database to advertise products to users in a customized fashion. The targeted marketing/advertising may be embodied in specialized advertising bars, banners or links, in a “treasure map” available to the user, in targeted emails, etc.

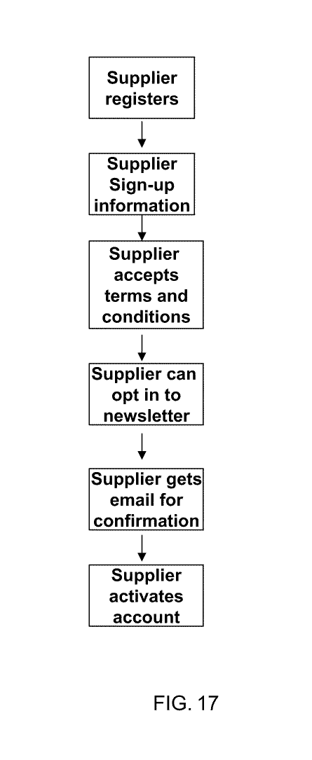

In an embodiment of the present invention, to be able to advertise products, a supplier first registers on the webpage as shown in FIG. 17. In an embodiment, a supplier provides sign-up information and accepts the applicable terms and conditions. In an embodiment, a supplier may opt in or out of certain features such as email alerts and/or newsletters, etc. In an embodiment, a confirmation is typically generated and may be confirmed by email or other suitable source. In embodiments, the supplier may then request a personal account to be created, which may be activated, for example, by sending the supplier an email and, in an embodiment, requesting a particular action by the supplier, such as following a hyperlink.

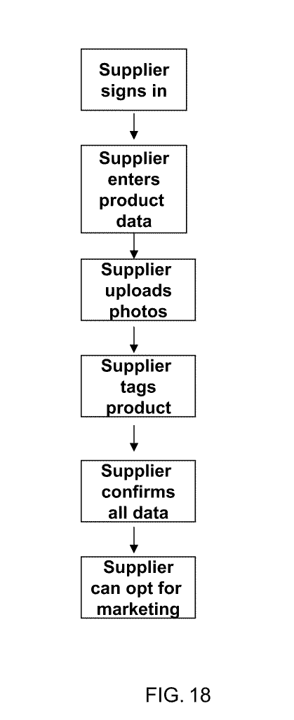

In an embodiment, a supplier may list his product(s) in the database, where the product(s) may be available for users to see and rate as shown in FIG. 18. In an embodiment, a supplier signs into the system and enters product data. In an embodiment, a supplier may include photos related to the products and may tag the products. In an embodiment, after entry, the supplier has the option to confirm the entered data. Once a supplier has entered the requested information, the supplier has various options for marketing to the users.

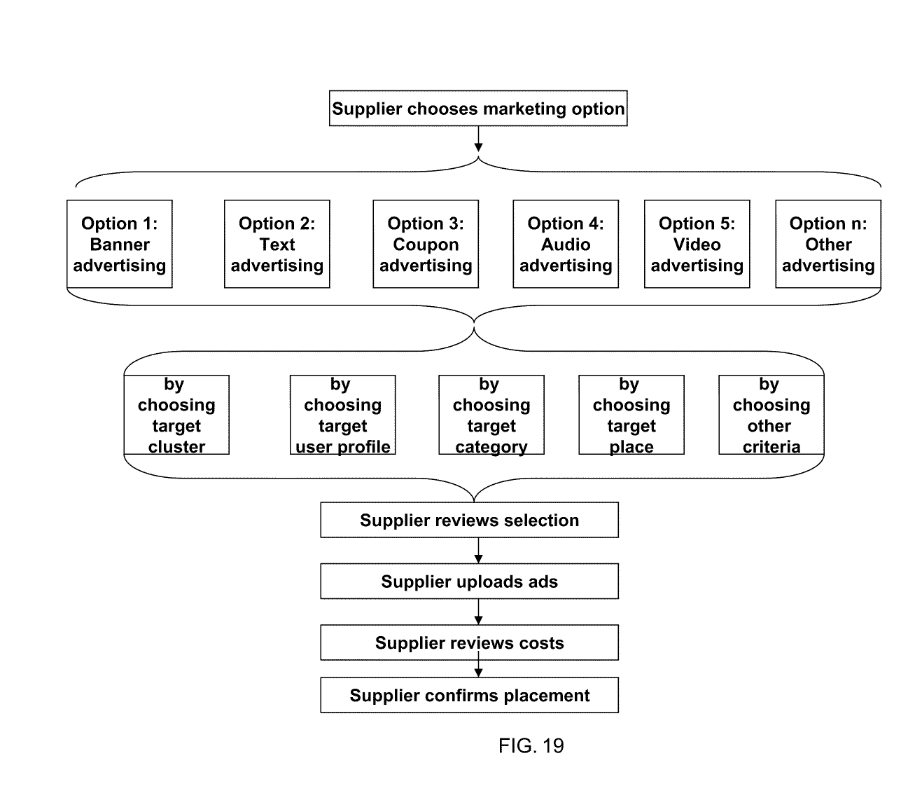

Various exemplary marketing options are illustrated in FIG. 19, together with the process for using a web-based system to create and order advertising. As may be seen in FIG. 19, a supplier may choose to create a marketing message by using banner advertising, text advertising, coupon advertising, audio advertising, video advertising or other forms of advertising, or combinations of the above options. FIG. 19 also provides examples for precision targeting possibilities like targeting by cluster information, user profile information (like age, gender, interests), by target category (such as users searching for hotel information), by target place (such as users searching for information about a certain geographic region) or by targeting through other criteria and information that have been provided by the users. In an embodiment, after a supplier selects the marketing options, the supplier may review the selection, and upload or create advertising targeting the particular group of interest. In an embodiment, the system may provide an integrated cost function in which options are provided with the associated costs. In an embodiment, the supplier may then confirm placement of the order of the advertising when all operations are completed.

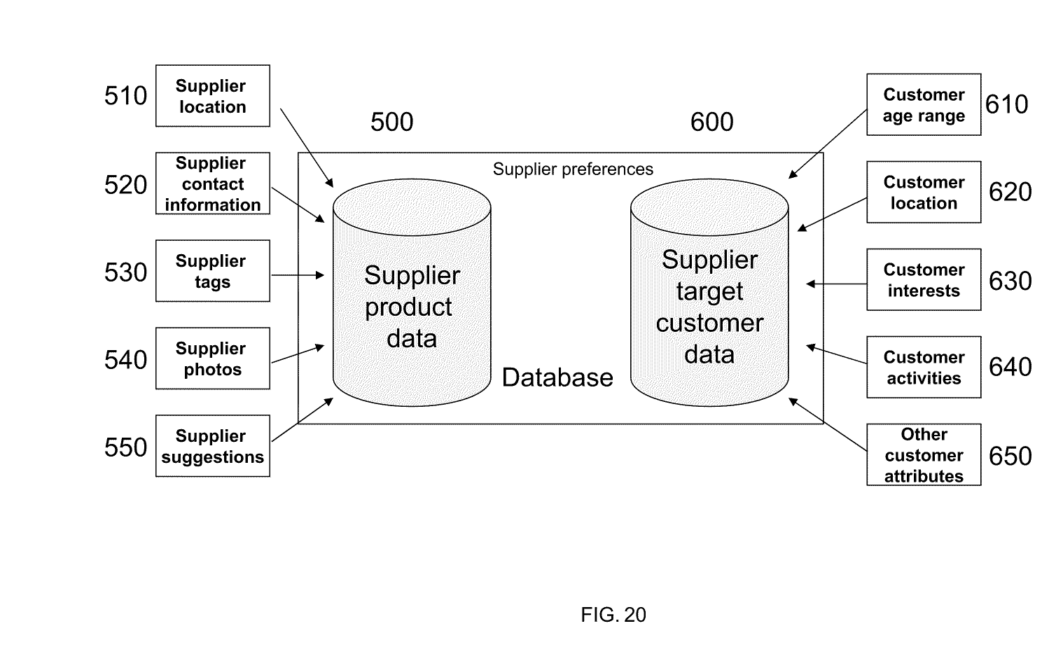

For a better understanding of embodiments of the present invention, FIG. 20 provides examples of data the supplier may provide to the database. Suppliers may enter data about their location 510, contact information 520, tags that describe their products 530, photos of their products 540, and/or other supplier-suggested information 550 into the supplier product database 500. Suppliers may also enter into the supplier target database 600 information on their targeted customers, such as customer age range 610, customer location 620, customer interests 630, customer activities 640 and/or other customer attributes 650.

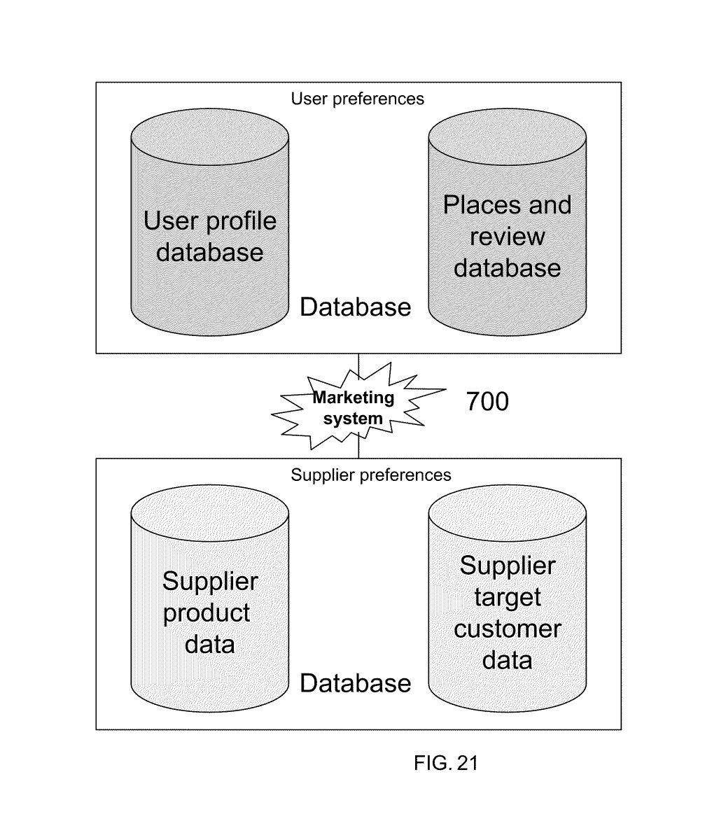

In an embodiment of the present invention, data provided by a supplier and data provided by a user may be combined in a marketing system 700 as shown in FIG. 21. While multiple databases are shown, for example, in FIG. 21, one or more databases may be used in accordance with embodiments of the present invention.

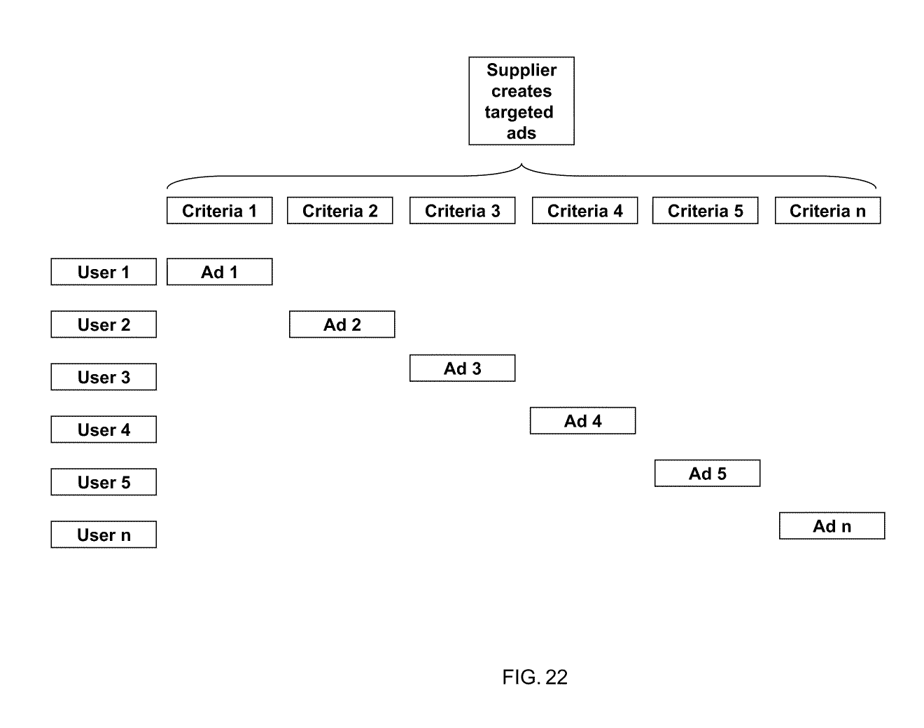

FIG. 22 illustrates how data in a database may be used to deliver highly targeted and highly relevant marketing and advertising information to users. The individual advertising shown to the different users may depend on the preferences entered into the database by the user and/or on the criteria selected for the advertising by the supplier. This way it is possible for a supplier to target each user with a different, customized marketing message.

In an embodiment, when advertising is displayed in the system, a particular order of display may be provided based on the size of the target audience. In an embodiment, the advertisements may be displayed with the first or top listed advertisement being the one with the smallest market. In an embodiment, the advertisements may thus be ordered and listed by a ranking of market size. For example, a series of advertisements may be displayed to an individual on one or more web-pages of the application. A first advertisement may be directed to, for example, men over the age of 50 that like golf and resort hotels. A second advertisement may be directed to all golfers. The size of the market for the first advertisement (as determined by the number of people in the system that match the defined characteristics) would be smaller than the size of the market for the second advertisement, and thus, in an embodiment, the first advertisement would be shown first (for example in a rotating display or list) or at the top of the list, etc. Such a system encourages the use of target advertising and provides a benefit to users that provide accurate profiles.

In an embodiment, an advertisement may contain links to websites, and, in a particular embodiment, may contain a link to a specific page, such as detailing a package or special offer. For example, if a user's profile indicates that the user likes romantic travel, an advertisement for bed and breakfasts may be provided with a link to a special weekend romance package.

In embodiments of the present invention, an interface for suppliers may be provided in which the market size(s) may be determined. Using such a function, a supplier/advertiser may select various criteria and then query the system for the size of that market. The supplier may then adjust the criteria as desired to arrive at a suitable market size having the desired characteristics.

In an embodiment, feedback may be provided to the suppliers in a variety of forms. For example, users may rate the supplier's advertisements. In addition, the system may generate a report showing demographics of the users that viewed a particular advertisement, those that clicked on the advertisement, and/or the ratings those users provided to the advertisement. Such information may assist the suppliers in providing better advertising in the future.

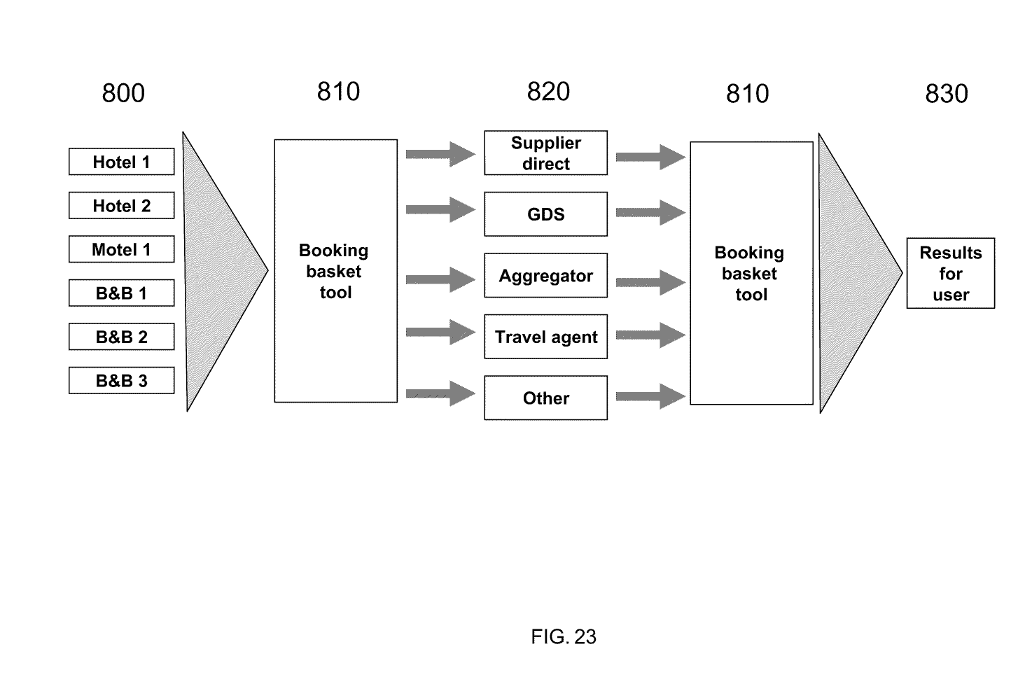

FIG. 23 illustrates how users may use a database to contact several suppliers simultaneously with requests for price quotes and proposals in accordance with an embodiment of the present invention. To do so, a user selects supplier products in which the user is interested (800) and moves them to a virtual shopping basket, shown as booking basket tool 810. In an embodiment, the user may also provide the tool with information about travel preferences for the specific trip as well as information about the price the user is willing to pay, the dates the user wants to travel and other information. Booking basket tool 810 uses the information provided to retrieve availability and price information through various sources 820 from suppliers by communication with the suppliers, directly or indirectly, through a global distribution system (GDS), a travel aggregator (e.g. Kayak.com), a travel agent or another source of information. The requested information may be returned to the booking basket tool 810 and through the tool delivered to the user. In an embodiment of the present invention, the process of getting the requested information may take 24 to 48 hours, or less. The tool allows users to communicate with multiple vendors without having to contact them individually. Furthermore, the tool allows users to communicate with smaller vendors that might not participate in reservation or global distribution systems and to compare the feedback from multiple vendors in an easy format.

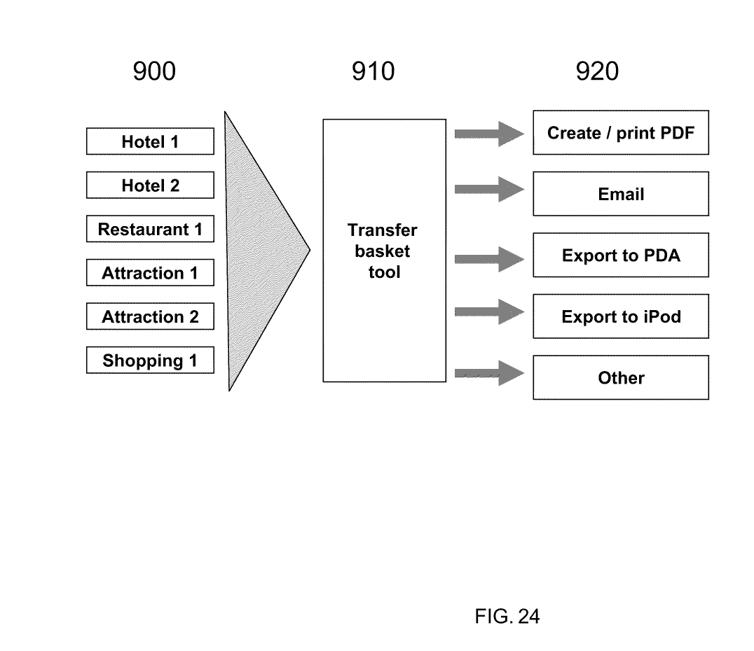

FIG. 24 shows how a user may use a transfer basket tool to export data from a database to other media in accordance with an embodiment of the present invention. In an embodiment, a user selects content and/or data the user wants to export (900) and moves the content and/or data to transfer basket tool 910. The user may select to which media the user wants to export the data, and the tool then exports the data to the medium of the user's choice (920), such as a PDF file, an email, a download to a PDA or other integrated media device or other suitable media. A transfer basket tool enables users to share data and make the data more portable. Instead of having to travel with an entire guide-book, a user may select the content and/or data the user considers relevant and download that content and/or data on a PDA to take with the user.

In an embodiment of the present invention users may also use location-based-services like global-positioning-systems (GPS) or wireless triangulation to quickly find places in their geographic vicinity that fit their interests and preferences. The same systems may be used to deliver marketing messages to the user that highlight travel products in the vicinity of the current user's location. These marketing messages may be targeted by the suppliers to match the interests and preferences of the individual user. In such an embodiment, an electronic device containing GPS or another location system may be integrated with a travel recommendation and/or targeted marketing system as discussed herein. In such embodiments, the location of the electronic device may be used to trigger messages/recommendations, etc. for the user based on the user's proximity to a particular location of interest. For example, if a user is passing a particular store, the system may provide a message indicating that there is a sale occurring in that store. In embodiments, the user may indicate in a profile which, how, and to what extent the user would like to receive such location-based notices and services.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

1-18. (canceled)

19. A computer implemented method for providing targeted advertising by a supplier to a user, comprising:
receiving in a database of a server user data for a plurality of users, the user data being directed to one or more characteristics;
receiving by the server a selection by the supplier of at least one of the one or more characteristics to target for the advertising;
receiving by the server from the supplier an advertisement for display to users having the one or more selected characteristics;
and displaying by the server the advertisement to users having the one or more selected characteristics.

20. The method of claim 19, wherein the one or more characteristics are at least one of demographic data of the user, user travel preferences, and user interests.

21. The method of claim 19, wherein the advertisement is one of a plurality of advertisements and the plurality of advertisements are displayed to a user in an order based on a number of users the particular advertisement is targeting, an advertisement directed to a smaller number of targeted users being ranked higher in priority than an advertisement directed to a larger number of targeted users.

22. An article of manufacture including a computer-readable medium having instructions stored thereon that, in response to execution by a computing device, cause the computing device to:
receive in a database user data for a plurality of users, the user data being directed to one or more characteristics;
receive a selection by a supplier of at least one of the one or more characteristics to target for advertising;
receive from the supplier an advertisement for display to users having the one or more selected characteristics;
and display the advertisement to users having the one or more selected characteristics.

23. The article of manufacture of claim 22, wherein the advertisement is one of a plurality of advertisements and the instructions, in response to execution by the computing device, further cause the computing device to display the plurality of advertisements in an order based on a number of users the particular advertisement is targeting, an advertisement directed to a smaller number of targeted users being ranked higher in priority than an advertisement directed to a larger number of targeted users.

24. A method for determining a target market size, comprising:
receiving in a database of a server user data for a plurality of users, the user data being directed to one or more characteristics;
receiving by the server a selection by the supplier of at least one of the one or more characteristics to target for the advertising; and
providing by the server to the supplier an indication of a number of users from among the plurality of users having the one or more selected characteristics.
